(19) United States
(12) Patent Application Publication
(10) Pub. No.: US 2023/0205031 A1
(43) Pub. Date: Jun. 29, 2023

(54) ELECTROCHROMIC COMPOSITION, ELECTROCHROMIC LAYER AND ELECTROCHROMIC DEVICE

(71) Applicant: INDUSTRIAL TECHNOLOGY RESEARCH INSTITUTE, Hsinchu (TW)

(72) Inventors: Hsiang-Jui CHEN, Hsinchu City (TW); Yi-Chang DU, Houlong Township (TW); Jauder JENG, Zhudong Township (TW); Jheng-Ying LI, Taoyuan City (TW)

(73) Assignee: INDUSTRIAL TECHNOLOGY RESEARCH INSTITUTE, Hsinchu (TW)

(21) Appl. No.: 18/068,957

(22) Filed: Dec. 20, 2022

Related U.S. Application Data
(63) Continuation-in-part of application No. 17/563,296, filed on Dec. 28, 2021, now abandoned.

(30) Foreign Application Priority Data
Oct. 31, 2022 (TW) 111141313

(51) Int. Cl. G02F 1/1516; G02F 1/155; G02F 1/1523

(52) U.S. Cl. CPC G02F 1/15165; G02F 1/155; G02F 1/1525

(57) ABSTRACT

An electrochromic composition, an electrochromic layer and an electrochromic device are provided. The electrochromic composition includes 20-80 parts by weight of polyimide, 20-80 parts by weight of silicon oxide nanoparticle, 1-50 parts by weight of electrochromic material, and 850 to 1200 parts by weight of solvent. The polyimide is a reaction product of a dianhydride and a diamine. The dianhydride and the diamine are as defined in the specification.

### CROSS REFERENCE TO RELATED APPLICATIONS

This application is a Continuation-In-Part of U.S. patent application Ser. No. 17/563,296, filed on Dec. 28, 2021, the entirety of which is incorporated by reference herein. Further, the application claims priority of Taiwan Patent Application No. 111141313, filed on Oct. 31, 2022, the entirety of which is incorporated by reference herein.

### TECHNICAL FIELD

The disclosure relates to an electrochromic composition, an electrochromic layer and an electrochromic device.

### BACKGROUND

Electrochromic and related devices are attractive options in the green energy industry due to their low driving voltage and bistability.

The organic compound, which can be used as an electrochromic material, has the advantages of colorful and fast color-change. Organic electrochromic materials are often combined with cross-linkable polymer materials or a cross-linking agent to form a composition, in order to improve the processability and the mechanical properties of the film prepared from the composition. However, it is not easy to store an electrochromic composition at room temperature for a long time.

### SUMMARY

The disclosure provides an electrochromic composition. According to the embodiments of the disclosure, the electrochromic composition can include 20 to 80 parts by weight of polyimide, 20 to 80 parts by weight of silicon oxide nanoparticle, 1 to 50 parts by weight of electrochromic material, and 850 to 1200 parts by weight of organic substance, wherein the total weight of the polyimide and the silicon oxide nanoparticle is 100 parts by weight. According to embodiments of the disclosure, the polyimide, the silicon oxide nanoparticle, and the electrochromic material is uniformly dispersed in the organic substance. According to embodiments of the disclosure, polyimide is a product of a dianhydride and a diamine via a reaction (such as imidization), wherein the dianhydride can be

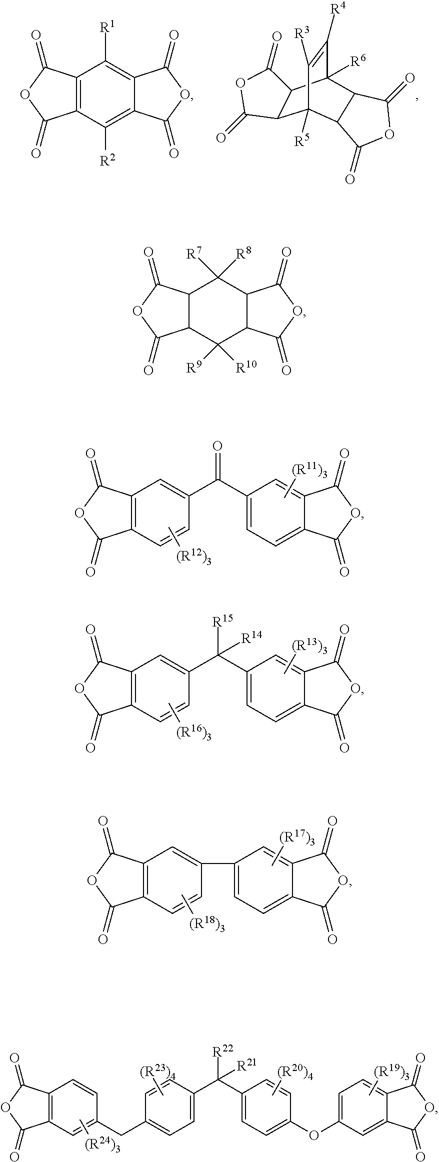

or a combination thereof. The diamine can be

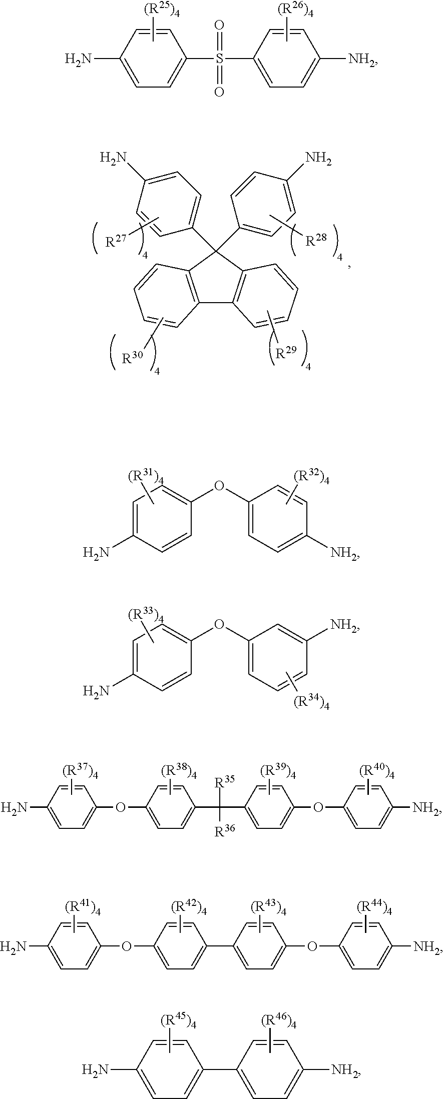

or a combination thereof. R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸, R²⁹, R³⁰, R³¹, R³², R³³, R³⁴, R³⁵, R³⁶, R³⁷, R³⁸, R³⁹, R⁴⁰, R⁴¹, R⁴², R⁴³, R⁴⁴, R⁴⁵, or R⁴⁶ can be independently hydrogen, fluorine, C₁₋₃ alkyl group, or C₁₋₃ fluoroalkyl group.

According to embodiments of the disclosure, the disclosure provides an electrochromic layer, wherein the electrochromic layer is prepared from the aforementioned electrochromic composition.

According to embodiments of the disclosure, the disclosure provides an electrochromic device. The electrochromic device includes a first conductive layer, the electrochromic layer of the disclosure, and a second conductive layer, wherein the first conductive layer and the second conductive layer are both disposed on a bottom surface of the electrochromic layer, or the first conductive layer is disposed on the top surface of the electrochromic layer and the second conductive layer is disposed on the bottom surface of the electrochromic layer.

A detailed description is given in the following embodiments.

### BRIEF DESCRIPTION OF THE DRAWINGS

FIG. 1 is a cross section view of an electrochromic device according to embodiments of the disclosure.

FIG. 2 is a cross section view of an electrochromic device according to some embodiments of the disclosure.

FIG. 3 is a schematic view of an electrochromic device having a single layer of conductive layer according to embodiments of the disclosure.

FIG. 4 is a cross section view of the electrochromic device as shown in FIG. 3 taken along the line 4-4′.

FIG. 5 is a cross section view of an electrochromic device according to some embodiments of the disclosure.

### DETAILED DESCRIPTION

The electrochromic composition, electrochromic layer and electrochromic device of the disclosure are described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. As used herein, the term “about” in quantitative terms refers to plus or minus an amount that is general and reasonable to persons skilled in the art. As used herein, the term “about” in quantitative terms refers to plus or minus an amount that is general and reasonable to persons skilled in the art.

Moreover, the use of ordinal terms such as “first”, “second”, “third”, etc., in the disclosure to modify an element does not by itself connote any priority, precedence, or der of one claim element over another or the temporal order in which it is formed, but are used merely as labels to distinguish one claim element having a certain name from another element having the same name (but for use of the ordinal term) to distinguish the claim elements.

The disclosure provides an electrochromic composition, electrochromic layer, and electrochromic device employing the same. Since the electrochromic composition of the disclosure has a suitable range of viscosity, the electrochromic composition of the disclosure is suitable to form an electrochromic layer of an electrochromic device via a wet process (such as spin coating process, or blade coating process). Due to the addition of the polyimide having specific structure (i.e. non-crosslinkable polyimide, such as: polyimide without hydroxyl group), the obtained electrochromic composition is free of cros slinking agent and has a long term storability (such as greater than 30 days). The electrochromic composition of the disclosure is suitable to form a coating via a wet process by means of the addition of polyimide and the specific range of solid content of the electrochromic composition, resulting in solving the inconvenience that the element made of conventional electrochromic materials is manufactured via vacuum impregnation process. Due to the addition of silicon oxide nanoparticle, the silicon oxide nanoparticle performs a self-crosslinking reaction to form a network structure after subjecting the obtained coating to a heating process, thereby reducing the fluidity of the electrochromic layer and increasing the ionic conductivity of the electrochromic layer. In addition, the network structure of the cross-linked silicon oxide nanoparticle can improve the coloring/fading speed of the electrochromic device.

According to embodiments of the disclosure, the electrochromic composition can include 20 to 80 parts by weight of polyimide, 20 to 80 parts by weight of silicon oxide nanoparticle, 1 to 50 parts by weight of electrochromic material, and 850 to 1200 parts by weight of organic substance, wherein the total weight of the polyimide and the silicon oxide nanoparticle is 100 parts by weight. According to embodiments of the disclosure, the polyimide, the silicon oxide nanoparticle, and the electrochromic material is uniformly dispersed in the organic substance.

According to embodiments of the disclosure, the polyimide of the disclosure can be non-crosslinkable polyimide. Namely, the polyimide does not have other functional groups (which can undergo a cross-linking reaction), besides the two terminal functional groups. For example, the polyimide of the disclosure can be polyimide which does not have hydroxyl group. According to embodiments of the disclosure, the polyimide of the disclosure can be a reaction product of a dianhydride and a diamine via a reaction (such as imidization). Since the polyimide of the disclosure can be non-crosslinkable polyimide, dianhydride does not have other functional groups (which can undergo a cross-linking reaction) besides two anhydride group; and the diamine does not have other functional groups (which can undergo a cross-linking reaction), besides two amine groups. According to embodiments of the disclosure, the dianhydride and/or diamine does not have hydroxyl group. According to embodiments of the disclosure, the dianhydride can be

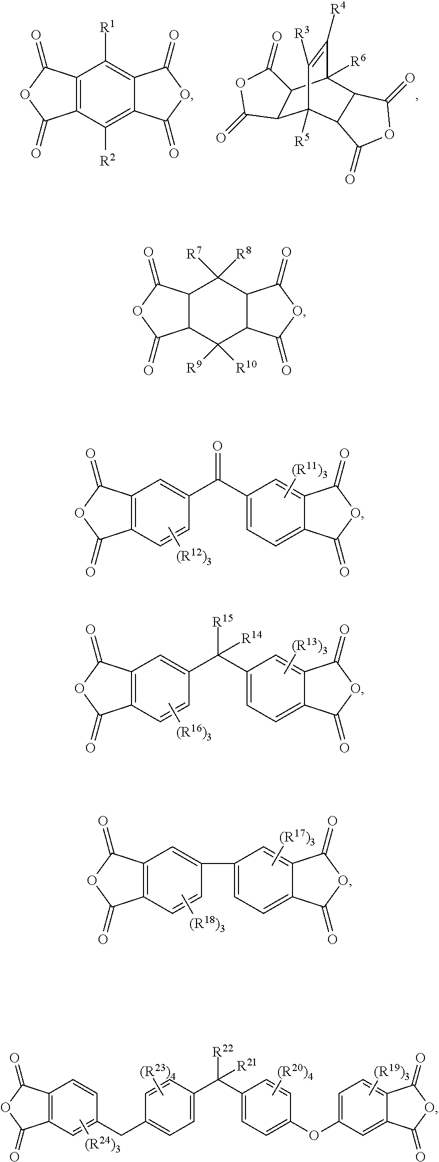

or a combination thereof. The diamine can be

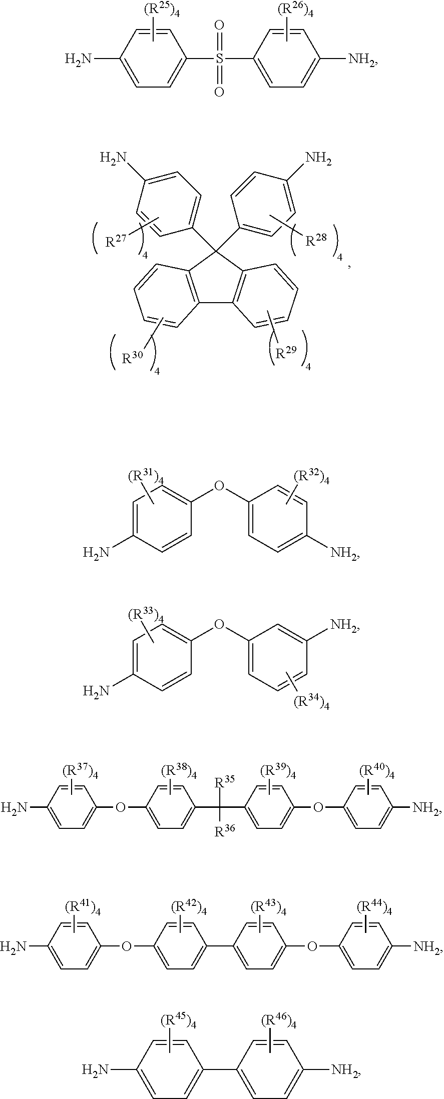

or a combination thereof. R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸, R²⁹, R³⁰, R³¹, R³², R³³, R³⁴, R³⁵, R³⁶, R³⁷, R³⁸, R³⁹, R⁴⁰, R⁴¹, R⁴², R⁴³, R⁴⁴, R⁴⁵, or R⁴⁶ can be independently hydrogen, fluorine, C₁₋₃ alkyl group, or C₁₋₃ fluoroalkylgroup. Due to the addition of the polyimide having specific structure (i.e. non-crosslinkable polyimide, such as polyimide without hydroxyl group), the electrochromic composition of the disclosure would not undergo a cross-linking reaction at room temperature, and has a long term storability (such as greater than 30 days).

According to embodiments of the disclosure, the C₁₋₃ alkyl group of disclosure can be linear or branched alkyl group. For example, C₁₋₃ alkyl group can be methyl, ethyl, propyl, or an isomer thereof. The C₁₋₃ fluoroalkyl group of the disclosure can be an alkyl group which a part of or all hydrogen atoms bonded on the carbon atom are replaced with fluorine atoms and can be linear or branched, such as fluoromethyl, fluoroethyl, fluoropropyl, or an isomer thereof. Herein, the fluoromethyl of the disclosure can be monofluoromethyl, difluoromethyl, or trifluoromethyl, and fluoroethyl can be monofluoroethyl, difluoroethyl, trifluoroethyl, tetrafluoroethyl, or perfluoroethyl. For example, R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸, R²⁹, R³⁰, R³¹, R³², R³³, R³⁴, R³⁵, R³⁶, R³⁷, R³⁸, R³⁹, R⁴⁰, R⁴¹, R⁴², R⁴³, R⁴⁴, R⁴⁵, or R⁴⁶ can be independently hydrogen, fluorine, methyl, ethyl, propyl, fluoromethyl, fluoroethyl, or fluoropropyl.

According to embodiments of the disclosure, the dianhydride can be pyromellitic dianhydride (PMDA), bicyclo [2.2.2]oct-7-ene-2,3,5,6-tetracarboxylic dianhydride (B 1317), 1,2,4,5-cyclohexane 1,2,4,5-cyclohexanetetracarboxylic dianhydride (HPMDA), 3,3′,4,4′ -benzophenonetetracarboxylic dianhydride (BTDA), 4,4′ -(hexafluoroisopropylidene)diphthalic anhydride (6FDA), 3,3,4,4-biphenyl tetracarboylic dianhydride (s-BPDA), 2,2-bis [4-(3,4-dicarboxyphenoxy)phenyl]propanedianhydride (BPADA), or a combination thereof. According to embodiments of the disclosure, the diamine can be 4,4′-oxydianiline (ODA), 2,2-bis [4-(4-aminophenoxy)phenyl] propane (BAPP), 4,4′-(1, 1′-biphenyl-4,4′-diyldioxy)dianiline (BAPB), 2,2-bis [4-(4-aminophenoxy)phenyl]hexafluoropropane (HFBAPP), 2,2′-bis(trifluoromethyl) 4,4′-diaminobiphenyl (TFMB), 4,4-diaminodiphenyl sulfone (4,4′ -DDS), 4,4′-diamino-2,2′-dimethylbiphenyl (m-TBHG), 9,9-bis(4-aminophenyl)fluorene (BAFL) or a combination thereof.

Since the polyimide of the disclosure is non-crosslinkable polyimide, the dianhydride used for preparing the polyimide does not have other functional groups (which can undergo a cross-linking reaction, such as hydroxyl group, or carboxyl) besides two anhydride group. Therefore, the diamine of the disclosure is not 3,3′-dihydroxybenzidine (HAB), 2,2-bis(3-amino-4-hydroxyphenyl)hexafluoropropane (BAFA), 2,2-bis(3-amino-4-hydroxylphenyl)propane (BAP), or 5,5′ -methylenebis(2-amino-benzoic-acid) (MBA).

According to embodiments of the disclosure, the polyimide of the disclosure can have a repeating unit, wherein the repeating unit can be

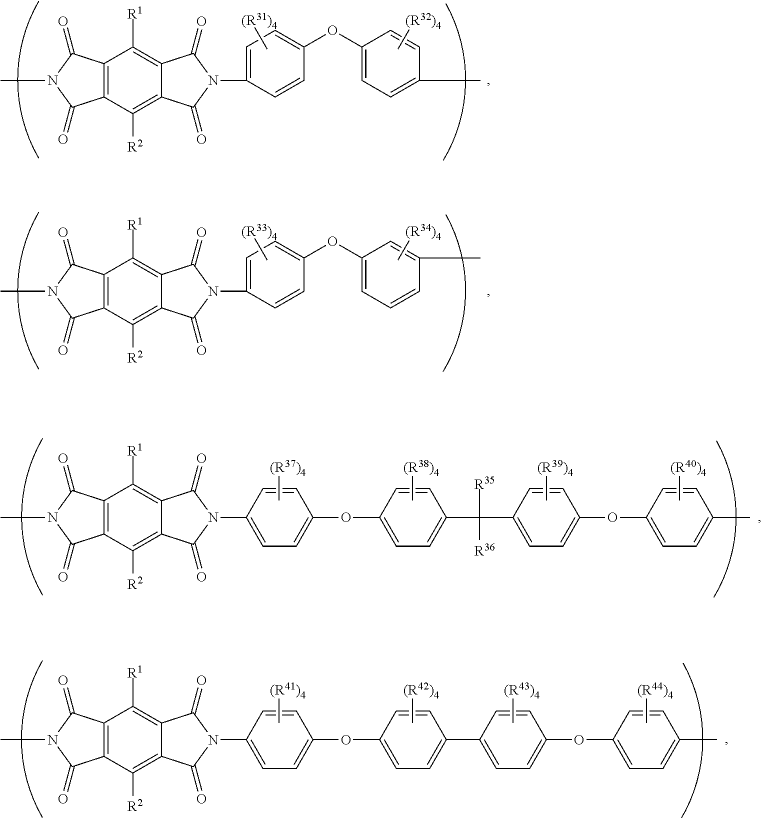

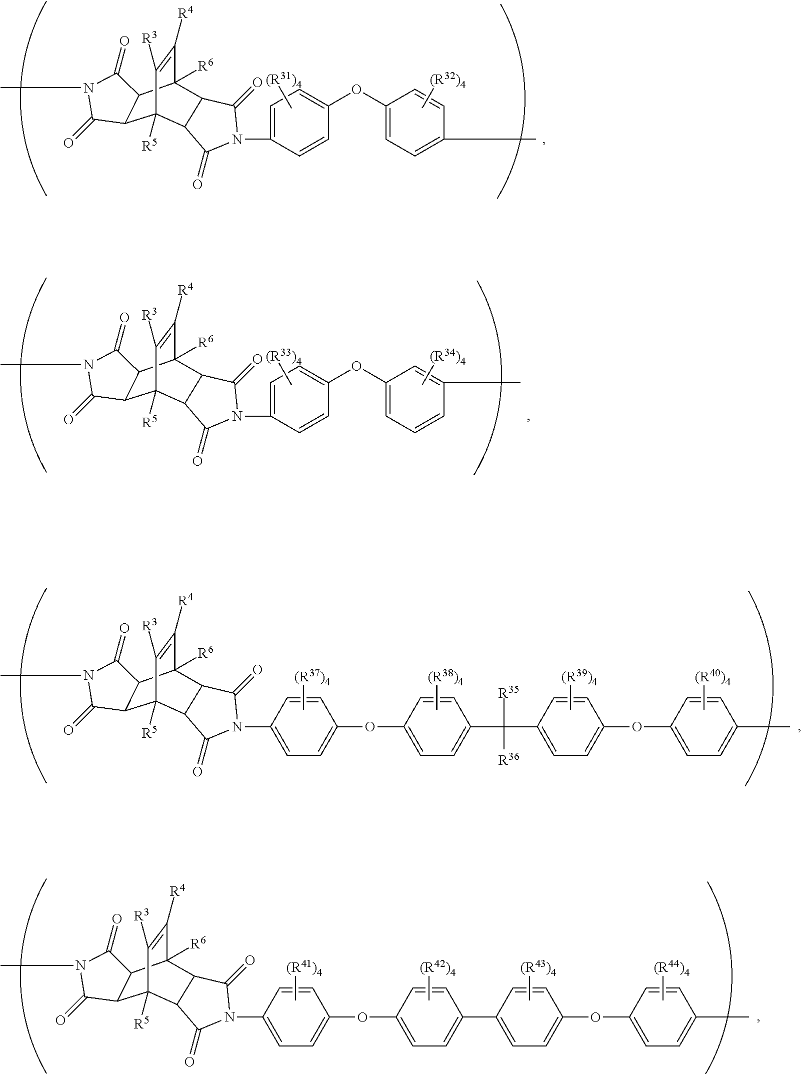

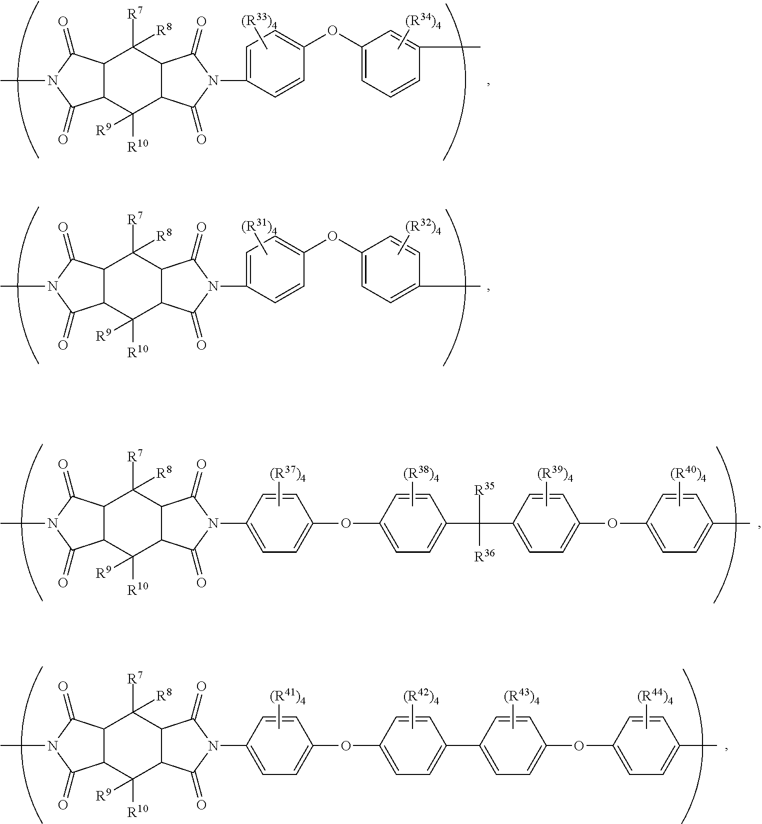

or a combination thereof, wherein R¹, R², R³, R⁴, R⁵, R⁶, R⁷, R⁸, R⁹, R¹⁰, R³¹, R³², r³³, R³⁴, R³⁵, R³⁶, R³⁷, R³⁸, R³⁹, R⁴⁰, R⁴¹, R⁴², R⁴³, or R⁴⁴ are the same as defined above.

According to embodiments of the disclosure, in order to maintain the processability of the obtained electrochromic composition, the gel viscosity (at 25° C.) of the polyimide of the disclosure can be between about 5,000 cps to 45,000 cps, such as between about 5,000 cps to 40,000 cps, between about 7,000 cps to 45,000 cps, between about 8,000 cps to 38,000 cps, or between about 10,000 cps to 45,000 cps. The viscosity is measured by a viscometer (BROOKFIELD DVELV, rotor # 64) with a speed set at 20rpm at 25° C.

According to embodiments of the disclosure, the viscosity of the electrochromic composition of the disclosure can be about 1,000 cps to 35,000 cps (such as 2,000 cps, 3,000 cps, 4,000 cps, 5,000 cps, 8,000 cps, 10,000 cps, 15,000 cps, 20,000 cps, 25,000 cps, 30,000 cps, or 35,000 cps). According to embodiments of the disclosure, the solid content of the electrochromic composition of the disclosure can be about 8 wt % to 15 wt %, such as 9 wt %,10 wt %, 11 wt %, 12 wt %, 13 wt %, or 14 wt %. Herein, the solid content means a weight percentage of the components of the electrochromic composition except the organic substance, based on the weight of the electrochromic composition. When the solid content of the electrochromic composition is too low, the electrochromic composition is apt to have a relatively low viscosity, thereby reducing the processability of the electrochromic composition (for example easily causing the coating prepared from the electrochromic composition to reflow) and resulting in that the thickness of the electrochromic layer made of the electrochromic composition is not easy to control (for example obtaining an electrochromic layer with a too thin thickness or an uneven thickness). When the solid content of the electrochromic composition is too high, the electrochromic composition is apt to have a relatively high viscosity, thereby reducing the processability of the electrochromic composition (for example the electrochromic composition would not form a coating). Moreover, the processability of the electrochromic composition is reduced (i.e. the electrochromic composition is not easy to form a coating via a wet process).

According to embodiments of the disclosure, the silicon oxide nanoparticle of the disclosure can have a particle size in a range from about 10 nm to 100 nm, such as in a range from 20 nm to 90 nm. After subjecting the silicon oxide nanoparticle to a heating process, the silicon oxide nanoparticle may undergo a self-crosslinking reaction, thereby chemically bonding among the silicon oxide nanoparticle via silicon-oxygen-silicon (Si—O—Si) bond, to form a network structure.

According to embodiments of the disclosure, the silicon oxide nanoparticle of the disclosure can be natural silicon oxide nanoparticle or synthetic silicon oxide nanoparticle. It should be noted that, when the particle size of silicon oxide nanoparticle is greater than 100 nm, the light transmittance of subsequently obtained electrochromic layer would be affected.

According to embodiments of the disclosure, the silicon oxide nanoparticle of the disclosure can be spherical silicon oxide nanoparticle. The term “spherical silicon oxide nanoparticle” of the disclosure means the silicon oxide nanoparticle has a first dimension, a second dimension, and a third dimension (i.e. length, width, and height), wherein the first dimension, second dimension, and third dimension are less than or 0 equal to 100 nm (such as in a range from about 10 nm to 100 nm). According to embodiments of the disclosure, a ratio of any two dimensions of the first dimension, second dimension, and third dimension of the spherical silicon oxide nanoparticle powder is in a range from 1:1.5 to 1.5:1.

According to embodiments of the disclosure, the electrochromic material can include a cathode electrochromic material, anode electrochromic material, or a combination thereof. According to embodiments of the disclosure, the electrochromic material can consist of a cathode electrochromic material and anode electrochromic material. According to embodiments of the disclosure, the cathode electrochromic material can include

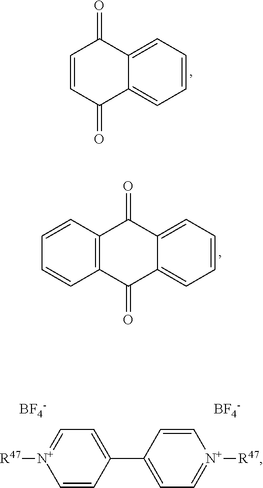

or a combination thereof, wherein R⁴⁷are independently hydrogen, or C₁₋₁₀ alkyl group. According to embodiments of the disclosure, the C₁₋₁₀ alkyl group of the disclosure can be linear or branched alkyl group, such as methyl, ethyl, propyl, butyl, pentyl, hexyl, heptyl, octyl, nonyl, decyl, or an isomer thereof.

According to embodiments of the disclosure, the anode electrochromic material can include

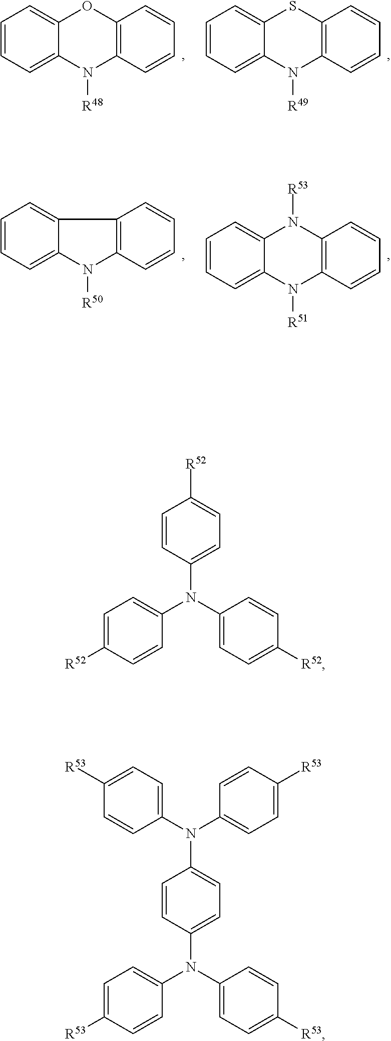

or a combination thereof, wherein R⁴⁸, R⁴⁹, R⁵⁰, or R⁵¹ are independently hydrogen, C₁₋₁₀ alkyl group, or phenyl group; and, R⁵², or R⁵³ are independently hydrogen, amine, or C₁₋₃ alkoxy group. According to embodiments of the disclosure, C₁₋₃ alkoxy group can be linear or branched alkoxy group. For example, C₁₋₃ alkoxy group can be methoxy, ethoxy, propoxy, or an isomer thereof.

According to embodiments of the disclosure, the organic substance is ethylene carbonate (EC), propyl acetate (PA), diethyl carbonate (DEC), dimethyl carbonate (DMC), ethylmethyl carbonate (EMC),γ-butyrolactone (GBL), propylene carbonate (PC), or a combination thereof.

According to embodiments of the disclosure, the electrochromic composition of the disclosure may further include an electrolyte salt. According to embodiments of the disclosure, the electrolyte salt can be organic ammonium salt, lithium salt, or a combination thereof. According to embodiments of the disclosure, the concentration of the electrolyte salt in the electrochromic composition is about 0.01M to 3.0M such as 0.02M, 0.03M, 0.05M, 0.08M, 0.1M, 0. 2M, 0.3M, 0.5M, 0.8M, 1.0M, 1.5M, 2.0M, or 2.5M. According to embodiments of the disclosure, the organic ammonium salt can be tetraalkylammonium bromate, tetraalkylammonium perchlorate, tetraalkylammonium tetrafluorobromide, or a combination thereof, wherein the number of the carbon atoms in each alkyl group of the organic ammonium salt can be or distinct from the same or different, and the alkyl group can be C₁₋₁₀ alkyl group. According to embodiments of the disclosure, the lithium salt can be LiPF₆, LiBF₄, LiAsF₆, LiSbF₆, LiCl₄, LiAlCl₄, LiGaCl₄, LiNO₃, LiC(SO₂CF₃)₃, LiN(SO₂CF₃), LiSCN, LiN(SO₂CF₃)₂, LiO₃SCF₂CF₃, LiC₆F₅S O₃, LiO₂CCF₃, LiSO₃F, LiB(C₆H₅), LiCF₃SO₃, or a combination thereof. According to embodiments of the disclosure, when the electrolyte salt is organic ammonium salt, the electrochromic composition can be subjected to a heating process to further facilitate the silicon oxide nanoparticle to undergo a self-crosslinking reaction.

According to embodiments of the disclosure, the electrochromic composition can consist of the polyimide, silicon oxide nanoparticle, electrochromic material, and organic substance. According to embodiments of the disclosure, the electrochromic composition can consist of the polyimide, silicon oxide nanoparticle, electrochromic material, organic substance, and electrolyte salt. According to embodiments of the disclosure, since the polyimide of the electrochromic composition is non-crosslinkable polyimide, the electrochromic composition can be free of crosslinking agent (such as isocyanate crosslinking agent).

According to embodiments of the disclosure, the electrochromic composition of the disclosure can optionally further include other ingredients, such as additives known by those skilled in the art, in order to improve the physicochemical properties of the layer prepared from the electrochromic composition. According to embodiments of the disclosure, examples of the additive can include, but not limited to, flame retardant, viscosity modifier, thixotropic agent, defoamer, leveling agent, surface treatment agent, UV absorber, stabilizer, and antioxidant.

According to embodiments of the disclosure, the disclosure provides an electrochromic layer, wherein the electrochromic layer is made of the aforementioned electrochromic composition. According to embodiments of the disclosure, the thickness of the electrochromic layer can be about 50 μm to 200 μm, such as 80 μm, 100 μm, 150 μm, or 180 μm.

According to embodiments of the disclosure, the disclosure provides a method for preparing the electrochromic layer. The method for preparing the electrochromic layer includes forming a coating of an electrochromic composition via a wet process, and subjecting the coating to a heating process, obtaining the electrochromic layer. By means of the heating process, the silicon oxide nanoparticle in the coating can undergo a self-crosslinking reaction, and a part of the organic substance in the coating is removed (such as about 60% to 90% of organic substance is removed) and a part of the organic substance is residual, thereby altering the coating into a mixture having colloidal electrolyte serving as the electrochromic layer. According to embodiments of the disclosure, the wet process can be wet coating process, such as spin coating, bar coating, blade coating, roller coating, dip coating, spray coating, or brush coating. According to embodiments of the disclosure, the temperature of the heating process can be 50° C. to 100° C., and the time period of the heating process can be about 10 minutes to 50 minutes, such as 10 minutes to 50 minutes, such as about 20 minutes to 40 minutes, or about 25 minutes to about 30 minutes.

According to embodiments of the disclosure, the disclosure provides an electrochromic device. The electrochromic device of the disclosure may include a first conductive layer, a second conductive layer , and the electrochromic layer of the disclosure, wherein the electrochromic layer includes a top surface and a bottom surface. According to embodiments of the disclosure, the first conductive layer may be disposed on the top surface of the electrochromic layer , and the second conductive layer may be disposed on the bottom surface of the electrochromic layer. Furthermore, according to embodiments of the disclosure, the first conductive layer and the second conductive layer may be both disposed on the bottom surface of the electrochromic layer.

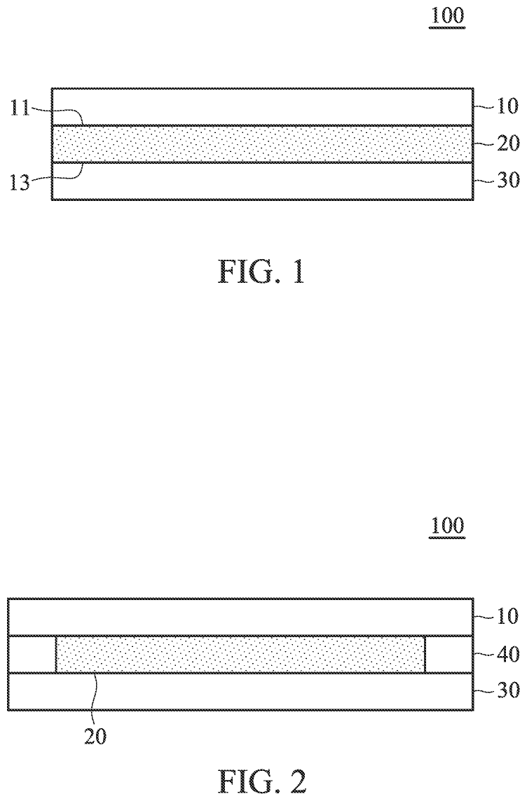

FIG. 1 is a cross section view of the electrochromic device 100 of the 0 disclosure. The electrochromic device 100 includes a first conductive layer 10, the electrochromic layer 20 of the disclosure, and a second conductive layer 30, wherein the electrochromic layer of the disclosure 20 has a top surface 11 and bottom surface 13. The first conductive layer 10 is disposed on the top surface 11 of the electrochromic layer 20, and the second conductive layer 30 is disposed on the bottom surface 13 of the electrochromic layer 20. According to embodiments of the disclosure, at least one of the first conductive layer 10 and the second conductive layer 30 is a transparent conductive layer. According to embodiments of the disclosure, the first conductive layer 10 and the second conductive layer 30 are both transparent conductive layers. According to embodiments of the disclosure, the transparent conductive layer may be indium tin oxide (ITO), indium zinc oxide (IZO), aluminum zinc oxide (AZO), or zinc oxide (ZnO).

According to embodiments of the disclosure, the electrochromic device of the disclosure may further include a thin film transistor array substrate. Herein, the first conductive layer is disposed on the top surface of the electrochromic layer and the second conductive layer is disposed on the bottom surface of the electrochromic layer, and the second conductive layer may be an electrode of the thin film transistor array substrate (such as pixel electrode). When the electrochromic device of the disclosure further includes the thin film transistor array substrate, the coloring speed of the electrochromic device can be increased (i.e. the time taken by a change of the visible light transmittance at 550 nm of the electrochromic device achieving 50% is reduced).

Especially, when applying thin film transistor array substrate to large-size electrochromic device (e.g. electrochromic device having a size equal to or larger than 10 inches), the time taken by a change of the visible light transmittance at 550 nm of the electrochromic device achieving 50% is obviously reduced.

According to embodiments of the disclosure, the method for preparing the electrochromic device 100 as shown in FIG. 1 includes following steps. First, a second conductive layer 30 is provided. Next, a coating of the electrochromic composition of the disclosure is formed on the second conductive layer 30 via a wet process. Next, the coating is subjected to a heating process, obtaining the electrochromic layer 20. Next, a first conductive layer 10 is disposed on the electrochromic layer 20.

According to embodiments of the disclosure, the electrochromic device 100 can further includes an encapsulation layer 40 is disposed on the second conductive layer 30, in order to define a containment region, and the electrochromic layer 20 is disposed in containment region, as shown in FIG. 2. According to embodiments of the disclosure, the encapsulation layer 40 may be formed by curing an encapsulant.

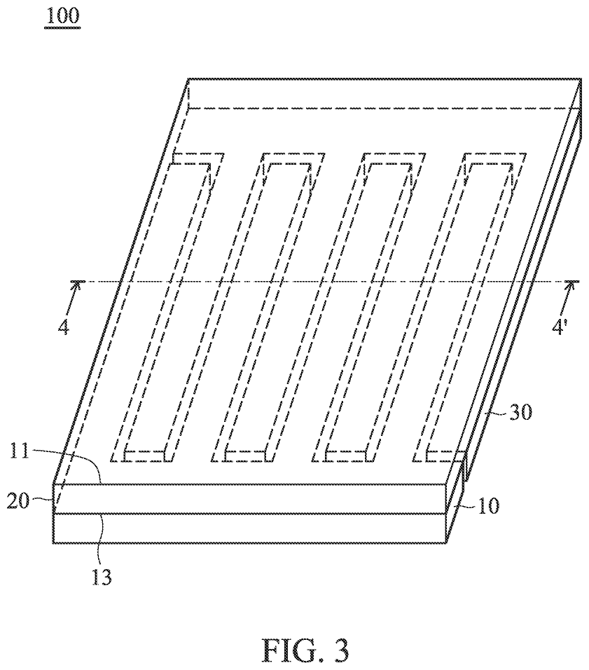

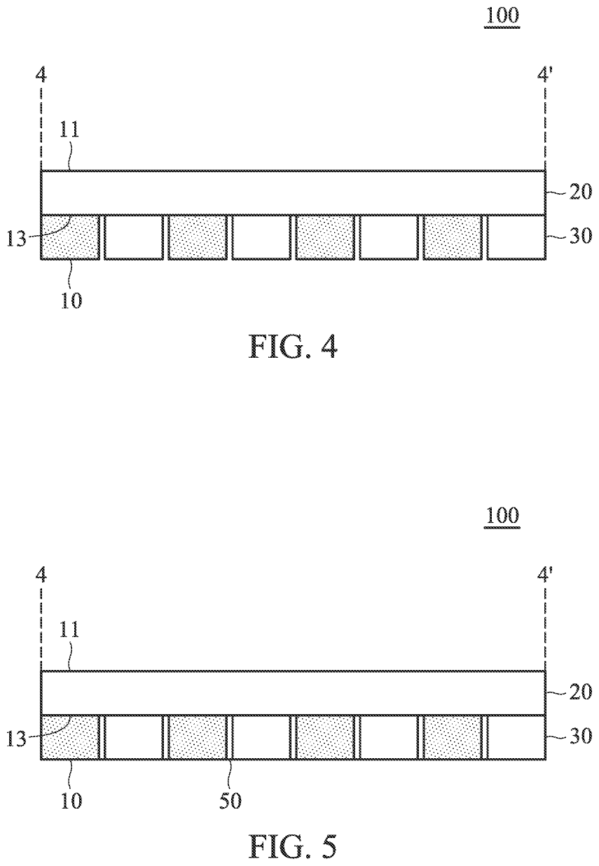

FIG. 3 is a schematic view of an electrochromic device 100 according to some embodiments of the disclosure. The electrochromic device 100 includes a first conductive layer 10, the electrochromic layer of the disclosure 20, and a second conductive layer 30, wherein the electrochromic layer of the disclosure 20 has a top surface 11 and a bottom surface 13. The first conductive layer 10 and the second conductive layer 30 are both disposed on the bottom surface 13 of the electrochromic layer 20, and the first conductive layer 10 does not contact with the second conductive layer 30 (i.e. the first conductive layer 10 does not electrically connect to the second conductive layer 30). According to embodiments of the disclosure, the top surface of the first conductive layer 10 is coplanar with the top surface of the second conductive layer 30, and the bottom surface of the first conductive layer 10 is coplanar with the bottom surface of the second conductive layer 30. According to embodiments of the disclosure, the first conductive layer 10 is separated from the second conductive layer 30 by a space, as shown in FIG. 4. FIG. 4 is a cross section view of the electrochromic device as shown in FIG. 3 taken along the line 4-4′.

Furthermore, according to some embodiments of the disclosure, the first conductive layer 10 is separated from the second conductive layer 30 by a spacer layer 50, as shown in FIG. 5. According to embodiments of the disclosure, suitable materials of the spacer 50 are organic material, dielectric material, or a combination thereof. According to embodiments of the disclosure, the material of the spacer layer 50 can be the same as the material of the electrochromic layer 20.

According to embodiments of the disclosure, the first conductive layer 10 and the second conductive layer 30 can be a patterned conductive layer. The orthogonal projection of the first conductive layer 10 onto the electrochromic layer 20 and/or the orthogonal projection of the second conductive layer 30 onto the electrochromic layer 20 may has a shape of polygon, circle, semi-circle, oval, semi-oval, irregular shape, or a combination thereof. For example, the shape of orthogonal projection of the first conductive layer 10 onto the electrochromic layer 20 and/or the shape of orthogonal projection of the second conductive layer 30 onto the electrochromic layer 20 may be comb-shaped. According to embodiments of the disclosure, a pattern of the first conductive layer 10 is complementary to a pattern of the second conductive layer 30 (i.e. the shape of orthogonal projection of the first conductive layer 10 onto the electrochromic layer 20 is complementary to the shape of orthogonal projection of the second conductive layer 30 onto the electrochromic layer 20. According to embodiments of the disclosure, the first conductive layer 10 and the second conductive layer 30 may both be transparent conductive layers. According to embodiments of the disclosure, the transparent conductive layer may be indium tin oxide (ITO), indium zinc oxide (IZO), aluminum zinc oxide (AZO), or zinc oxide (ZnO).

According to embodiments of the disclosure, the method for preparing the electrochromic device 100 as shown in FIG. 3 may include following steps. First, a conductive film is provided, wherein the conductive film may be disposed on a substrate. Next, the conductive film is subjected to a patterning process, forming the first conductive layer 10 and the second conductive layer 30 separated from each other.

Next, the electrochromic layer 20 is disposed on the first conductive layer 10 and second conductive layer 30.

Below, exemplary embodiments will be described in detail so as to be easily realized by a person having ordinary knowledge in the art. The inventive concept may be embodied in various forms without being limited to the exemplary embodiments set forth herein.

### EXAMPLES

Preparation of γ-butyrolactone solution having silicon oxide nanoparticle

### Preparation Example 1

An aqueous silicon oxide nanoparticle solution (commercially available from Nissan chemical with a trade number of Snow-O20, silicon oxide nanoparticle having a particle size of about 25-50 nm) was provided. Next, the aqueous silicon oxide nanoparticle solution was mixed with γ-butyrolactone (GBL), obtaining a mixture, wherein the weight ratio of γ-butyrolactone to the aqueous silicon oxide nanoparticle solution was 46.8:100. Next, water of the mixture was removed by rotary evaporator, and the result was diluted by γ-butyrolactone, obtaining silicon-oxide-nanoparticle-containing γ-butyrolactone solution. In particular, the silicon-oxide-nanoparticle-containing γ-butyrolactone solution had a solid content of 10 wt % (i.e. the amount of silicon oxide nanoparticle was 10 wt %, based on the weight of the silicon-oxide-nanoparticle-containing γ-butyrolactone solution.

Preparation of electrochromic-material-containing γ-butyrolactone solution having

### Preparation Example 2

A cathode electrochromic material (having a structure of

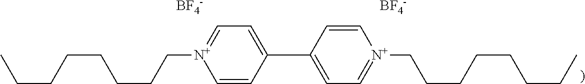 [SMILES: CCCCCCCC[n+]1ccc(-c2cc[n+](CCCCCCCC)cc2)cc1 ; "BF4-" ; "BF4-"]

(5 parts by weight), an anode electrochromic material (manufactured and sold by ACROS with a trade number of 92-84-2) (14 parts by weight), and tetrabutylammonium tetrafluoroborate (1 parts by weight) were provided to mix with γ-butyrolactone (GBL) (171 parts by weight), obtaining a electrochromic-material-containing γ-butyrolactone solution, the total amount of the cathode electrochromic material and the anode electrochromic material was 10 wt %, based on the weight of electrochromic-material-containing γ-butyrolactone solution.

Preparation of polyimide-containing γ-butyrolactone solution

### Preparation Example 3

A non-crosslinkable polyimide (having a first repeating unit represented by a structure of

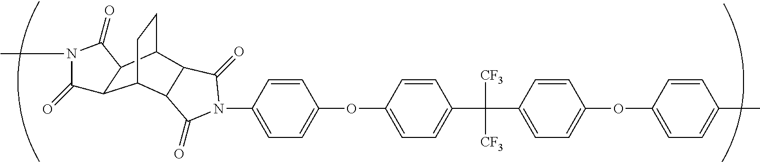

and a second repeating unit represented by a structure of

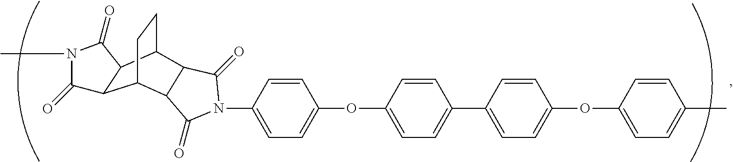

wherein the amount ratio of the first repeating unit and the second repeating unit was about 1:2, and the polyimide was a random copolymer) (10 parts by weight) was provided and then mixed with γ-butyrolactone (GBL) (90 parts by weight), obtaining a polyimide-containing γ-butyrolactone solution (1), wherein the polyimide-containing γ-butyrolactone solution (l) had a solid content of 10 wt % (i.e. the amount of the polyimide was 10 wt %, based on the weight of the polyimide-containing γ-butyrolactone solution (1)).

Preparation Example 4

### A crosslinkable polyimide (having a first repeating unit represented by a structure of

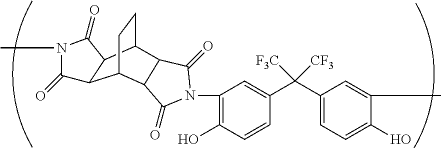

and a second repeating unit represented by a structure of

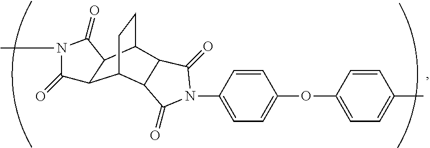

wherein the amount ratio of the first repeating unit and the second repeating unit was about2:3, and the polyimide was a random copolymer) (10 parts by weight) was provided and then mixed with γ-butyrolactone (GBL) (90 parts by weight), obtaining a polyimide-containing γ-butyrolactone solution (2), wherein the polyimide-containing γ-butyrolactone solution (2) had a solid content of 10 wt % (i.e. the amount of the polyimide was 10 wt %, based on the weight of the polyimide-containing γ-butyrolactone solution (2)).

Preparation Example 5

A non-crosslinkable polyimide (having a first repeating unit represented by a structure of

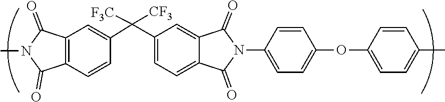

and a second repeating unit represented by a structure of

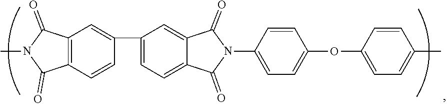

wherein the amount ratio of the first repeating unit and the second repeating unit was aboutl :1, and the polyimide was a random copolymer) (10 parts by weight) was provided and then mixed with γ-butyrolactone (GBL) (90 parts by weight), obtaining a polyimide-containing γ-butyrolactone solution (3), wherein the polyimide-containing γ-butyrolactone solution (3) had a solid content of 10 wt % (i.e. the amount of the polyimide was 10 wt %, based on the weight of the polyimide-containing γ-butyrolactone solution (3)).

### Preparation Example 6

A non-crosslinkable polyimide (having a first repeating unit represented by a structure of

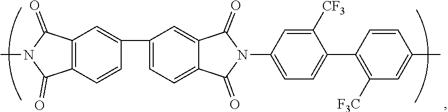

a second repeating unit represented by a structure of a structure of

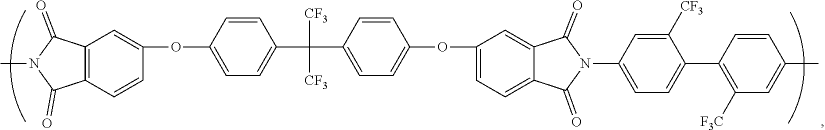

a third repeating unit represented by a structure of

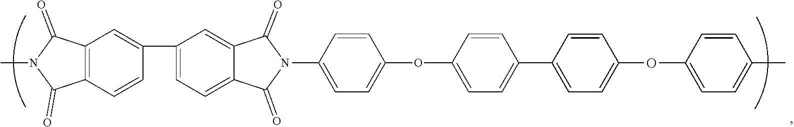

a fourth repeating unit represented by a structure of, the amount ratio of the first repeating unit, second repeating unit, third repeating unit, and fourth repeating unit was about 1:1:1:1, and the polyimide was a random copolymer) (10 parts by weight) was provided and then mixed with γ-butyrolactone (GBL) (90 parts by weight), obtaining a polyimide-containing γ-butyrolactone solution (4), wherein the polyimide-containing γ-butyrolactone solution (4) had a solid content of 10 wt % (i.e. the amount of the polyimide was 10 wt %, based on the weight of the polyimide-containing γ-butyrolactone solution (4)).

### Preparation Example 7

A non-crosslinkable polyimide (having a first repeating unit represented by a structure of

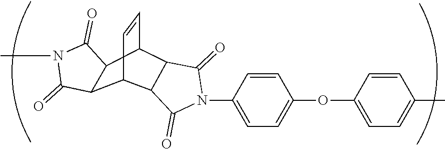

and a second repeating unit represented by a structure of

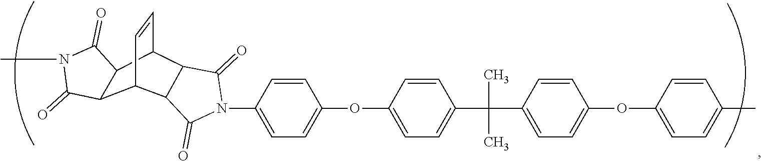

wherein the amount ratio of the first repeating unit and the second repeating unit was about3:1, and the polyimide was a random copolymer) (10 parts by weight) was provided and then mixed with γ-butyrolactone (GBL) (90 parts by weight), obtaining a polyimide-containing γ-butyrolactone solution (5), wherein the polyimide-containing γ-butyrolactone solution (5) had a solid content of 10 wt % (i.e. the amount of the polyimide was 10 wt %, based on the weight of the polyimide-containing γ-butyrolactone solution (5)).

### Preparation Example 8

A non-crosslinkable polyimide (having a first repeating unit represented by a structure of

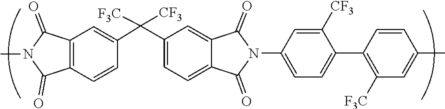

and a second repeating unit represented by a structure of

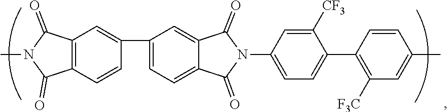

wherein the amount ratio of the first repeating unit and the second repeating unit was about 3:2, and the polyimide was a random copolymer) (10 parts by weight) was provided and then mixed with γ-butyrolactone (GBL) (90 parts by weight), obtaining a polyimide-containing γ-butyrolactone solution (6), wherein the polyimide-containing γ-butyrolactone solution (6) had a solid content of 10 wt % (i.e. the amount of the polyimide was 10 wt %, based on the weight of the polyimide-containing γ-butyrolactone solution (6)).

Preparation Example 9

A non-crosslinkable polyimide (having a first repeating unit represented by

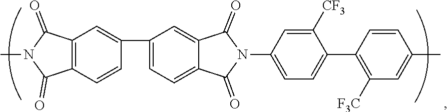

a structure of a second repeating unit represented by a structure of

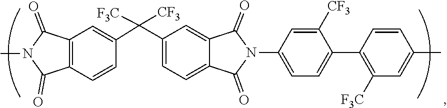

a third repeating unit represented by a structure of

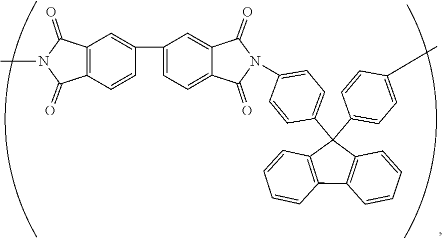

and a fourth repeating unit represented by a structure of

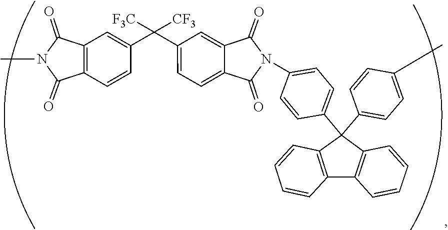

the ratio of the first repeating unit, second repeating unit, third repeating unit, and fourth repeating unit was about 1:1:1:1, and the polyimide was a random copolymer) (10 parts by weight) was provided and then mixed with γ-butyrolactone (GBL) (90 parts by weight), obtaining a polyimide-containing γ-butyrolactone solution (7), wherein the polyimide-containing γ-butyrolactone solution (7) had a solid content of 10 wt % (i.e. the amount of the polyimide was 10 wt %, based on the weight of the polyimide-containing γ-butyrolactone solution (7)).

Electrochromic composition

### EXAMPLE 1

The polyimide-containing γ-butyrolactone solution (1) of Preparation Example 3 (80 parts by weight), the silicon-oxide-nanoparticle-containing γ-butyrolactone solution of Preparation Example 1 (20 parts by weight), and the electrochromic-material -containing γ-butyrolactone solution of Preparation Example 2 (4 parts by weight) were mixed and then stirred at room temperature, obtaining the electrochromic composition (1).

### EXAMPLE 2

The polyimide-containing γ-butyrolactone solution (1) of Preparation Example 3 (60 parts by weight), the silicon-oxide-nanoparticle-containing γ-butyrolactone solution of Preparation Example 1 (40 parts by weight), and the electrochromic-material-containing γ-butyrolactone solution of Preparation Example 2 (3 parts by weight) were mixed and then stirred at room temperature, obtaining the electrochromic composition (2).

### EXAMPLE 3

The polyimide-containing γ-butyrolactone solution (1) of Preparation Example 3 (40 parts by weight), the silicon-oxide-nanoparticle-containing γ-butyrolactone solution of Preparation Example 1 (60 parts by weight), and the electrochromic-material-containing γ-butyrolactone solution of Preparation Example 2 (2 parts by weight) were mixed and then stirred at room temperature, obtaining the electrochromic composition (3).

### EXAMPLE 4

The polyimide-containing γ-butyrolactone solution (1) of Preparation Example 3 (20 parts by weight), the silicon-oxide-nanoparticle-containing γ-butyrolactone solution of Preparation Example 1 (80 parts by weight), and the electrochromic-material-containing γ-butyrolactone solution of Preparation Example 2 (1 parts by weight) were mixed and then stirred at room temperature, obtaining the electrochromic composition (4).

### COMPARATIVE EXAMPLE 1

The polyimide-containing γ-butyrolactone solution (1) of Preparation Example 3 (100 parts by weight), and the electrochromic-material-containing γ-butyrolactone solution of Preparation Example 2 (5 parts by weight) were mixed and then stirred at room temperature, obtaining the electrochromic composition (5).

### COMPARATIVE EXAMPLE 2

The polyimide-containing γ-butyrolactone solution (2) of Preparation Example 4 (100 parts by weight), electrochromic-material-containing γ-butyrolactone solution of Preparation Example 2 (5 parts by weight) and crosslinking agent (HDI trimer, with a trade number of Desmodur N3300) (0.06 parts by weight) were mixed and then stirred at room temperature, obtaining the electrochromic composition (6).

### COMPARATIVE EXAMPLE 3

The polyimide-containing γ-butyrolactone solution (2) of Preparation Example 4 (20 parts by weight), the silicon-oxide-nanoparticle-containing y-butyrolactone solution of Preparation Example 1 (80 parts by weight), electrochromic-material-containing γ-butyrolactone solution of Preparation Example 2 (1 parts by weight), and crosslinking agent (HDI trimer, with a trade number of Desmodur N3300) (0.06 parts by weight) were mixed and then stirred at room temperature, obtaining the electrochromic composition (7).

Fluidity Evaluation

The obtained electrochromic compositions (1)-(7) were coated on a glass substrate individually. After the glass substrate was placed in a direction orthogonal to the horizontal reference plane for 10s, the flow distance of the electrochromic composition was measured, and the results are shown in Table 1.

Evaluation of storability at room temperature

The electrochromic compositions (1)-(7) were stored at room temperature and observed, and the results are shown in Table 1.

TABLE 1

| | fluidity | |
|---|---|---|
| | (inverted | storability at |
| | test-cm/10 s) | room temperature |
| electrochromic | ~1.0 | the electrochromic |
| composition (1) | | composition exhibited |
| | | fluidity after storing at |
| | | room temperature greater |
| | | than 30 days |
| electrochromic | ~0.5 | the electrochromic |
| composition (2) | | composition exhibited |
| | | fluidity after storing at |
| | | room temperature greater |
| | | than 30 days |
| electrochromic | ~0.1 | the electrochromic |
| composition (3) | | composition exhibited |
| | | fluidity after storing at |
| | | room temperature greater |
| | | than 30 days |
| electrochromic | ~2.5 | the electrochromic |
| composition (4) | | composition exhibited |
| | | fluidity after storing at |
| | | room temperature greater |
| | | than 30 days |
| electrochromic | 1 | the electrochromic |
| composition (5) | | composition exhibited |
| | | fluidity after storing at |
| | | room temperature greater |
| | | than 30 days |
| electrochromic | <0.1 | the electrochromic |
| composition (6) | | composition did not |
| | | exhibit fluidity when |
| | | storing at room |
| | | temperature for a time |
| | | period less than 7 hours |
| electrochromic | <0.1 | the electrochromic |
| composition (7) | | composition did not |
| | | exhibit fluidity when |
| | | storing at room |
| | | temperature for a time |
| | | period less than 7 hours |

Electrochromic Device

### EXAMPLE 5

A glass substrate (with a size of 3*4 cm²) having an indium tin oxide (ITO) layer (with ITO thickness of 150 nm) was provided. Next, an encapsulation material was formed on the indium tin oxide (ITO) layer to define a containment region (with a size of 3*2cm²). Next, the electrochromic compositions (1)-(5) were individually coated on the indium tin oxide (ITO) layer by blade coating to form a coating with a thickness about 100 μm. Next, the coating was baked at 80° C. for 5 minutes, obtaining electrochromic layer. Next, another glass substrate with indium tin oxide (ITO) layer was correspondingly attached on the glass substrate having the electrochromic layer, obtaining the electrochromic devices (1)-(5) after encapsulation. Finally, the transmittance, coloring speed, and fading speed of the electrochromic devices (1)-(5) was evaluated, and the results are shown in Table 2.

The transmittance of the electrochromic device was measured with a visible light having a wavelength of 550 nm. The coloring speed of the electrochromic device was evaluated at a voltage of 1.3V, and the time period, which the color of the electrochromic device switched from transparency to dark color, was recorded. The fading speed of the electrochromic device was evaluated under a dark-color electrochromic device without voltage applied, and the time period, which the color of the electrochromic device switched from dark color to transparency, was recorded.

TABLE 2

| | electrochromic | transmittance | coloring | fading |
|---|---|---|---|---|
| | composition | (%) | speed (s) | speed (s) |
| electrochromic | electrochromic | 80.3 | 2.1 | 0.66 |
| device (1) | composition (1) | | | |
| electrochromic | electrochromic | 80.1 | 1.86 | 0.55 |
| device (2) | composition (2) | | | |
| electrochromic | electrochromic | 81.75 | 1.87 | 0.61 |
| device (3) | composition (3) | | | |
| electrochromic | electrochromic | 82.1 | 1.81 | 0.53 |
| device (4) | composition (4) | | | |
| electrochromic | electrochromic | 81.6 | 3.12 | 2.52 |
| device (5) | composition (5) | | | |

As shown in Table 1 and Table 2, the electrochromic composition of the disclosure is suitable to form an electrochromic layer of the electrochromic device via a wet process (such as spin coating process, or blade coating process), and has a long term storability (such as greater than 30 days) at room temperature. In addition, since the electrochromic device is prepared from the electrochromic composition of the disclosure, the electrochromic device has a superior visible light transmittance and an improved coloring/fading speed.

### EXAMPLE 6

A glass substrate (with a size of 6*10cm²) having two comb-shaped indium tin oxide (ITO) layers (with a line width of 1 mm, a line interval of 1 mm, and ITO thickness of 150 nm) was provided, wherein the two comb-shaped indium tin oxide (ITO) layers were separated from each other. Next, the electrochromic composition (2) was coated on the indium tin oxide (ITO) layer by blade coating to form a coating with a thickness about 100 μm.

Next, the coating was baked at 80° C. for 5 minutes, obtaining electrochromic layer. Next, another glass substrate with indium tin oxide (ITO) layer was correspondingly attached on the glass substrate having the electrochromic layer, obtaining the electrochromic device (6) after encapsulation. Next, the transmittance of the turn-off electrochromic device (6) was measured with a visible light having a wavelength of 550 nm, and the result is shown in Table 3. Next, the electrochromic device (6) was driven with a bias voltage of 1.8V and the transmittance of the turn-on electrochromic device (6) was measured with a visible light having a wavelength of 550 nm, and the result is shown in Table 3.

### EXAMPLE 7

Example 7 was performed in the same manner as in Example 6, except that the line width of the comb-shaped indium tin oxide (ITO) layer was reduced from 1 mm to 0.5 mm, and the line interval of the comb-shaped indium tin oxide (ITO) layer was reduced from 1 mm to 0.5 mm, obtaining the electrochromic device (7). Next, the transmittance of the turn-off electrochromic device (7) was measured with a visible light having a wavelength of 550 nm, and the result is shown in Table 3. Next, the electrochromic device (7) was driven with a bias voltage of 1.8V and the transmittance of the turn-on electrochromic device (7) was measured with a visible light having a wavelength of 550 nm, and the result is shown in Table 3.

### EXAMPLE 8

Example 8 was performed in the same manner as in Example 6, except that the line width of the comb-shaped indium tin oxide (ITO) layer was reduced from 1 mm to 0.1 mm, and the line interval of the comb-shaped indium tin oxide (ITO) layer was reduced from 1 mm to 0.1 mm, obtaining the electrochromic device (8). Next, the transmittance of the turn-off electrochromic device (8) was measured with a visible light having a wavelength of 550 nm, and the result is shown in Table 3. Next, the electrochromic device (8) was driven with a bias voltage of 1.8V and the transmittance of the turn-on electrochromic device (8) was measured with a visible light having a wavelength of 550 nm, and the result is shown in Table 3.

TABLE 3

transmittance (%) (550 nm)

| | | turn-on (1.8 V) |
|---|---|---|
| | turn-off | (after 10 sec) |
| electrochromic | 82.75% | 37.38 |
| device (6) | | |
| electrochromic | 81.14% | 32.25% |
| device (7) | | |
| electrochromic | 80.49% | 13.02% |
| device (8) | | |

As shown from Table 3, the turn-off transmittance of the electrochromic device with a single layer of indium tin oxide (ITO) layer is more than 80%. In comparison with the electrochromic device having two indium tin oxide (ITO) layers, the turn-on transmittance of the electrochromic device with a single layer of indium tin oxide (ITO) layer of the disclosure is further improved. Furthermore, the transmittance variation after operation of the electrochromic device with a single layer of indium tin oxide (ITO) layer of the disclosure may be greater than or equal to 45% or even up to about 68%

### EXAMPLE 9

A thin film transistor array substrate (with a size of 22*15 cm²) having an indium tin oxide (ITO) layer was provided. Next, the electrochromic composition (2) was coated on the indium tin oxide (ITO) layer by blade coating to form a coating with a thickness about 100 μm. Next, the coating was baked at 80° C. for 5 minutes, obtaining electrochromic layer. Next, another glass substrate with indium tin oxide (ITO) layer was correspondingly attached on the glass substrate having the electrochromic layer, obtaining the electrochromic device (9) after encapsulation.

The electrochromic device (9) was driven with a bias voltage of 2.0V and the coloring speed (i.e. the time taken by a change of the visible light transmittance at 550 nm of the electrochromic device achieving 50%) of the electrochromic device (9) was evaluated. The coloring speed of the electrochromic device (9) was 12 seconds.

It will be clear that various modifications and variations can be made to the disclosed methods and materials. It is intended that the specification and examples be considered as exemplary only, with the true scope of the disclosure being indicated by the following claims and their equivalents.

What is claimed is:

1. An electrochromic composition, comprising:
20 to 80 parts by weight of a polyimide, wherein the polyimide is a reaction product of a dianhydride and a diamine, wherein the dianhydride is 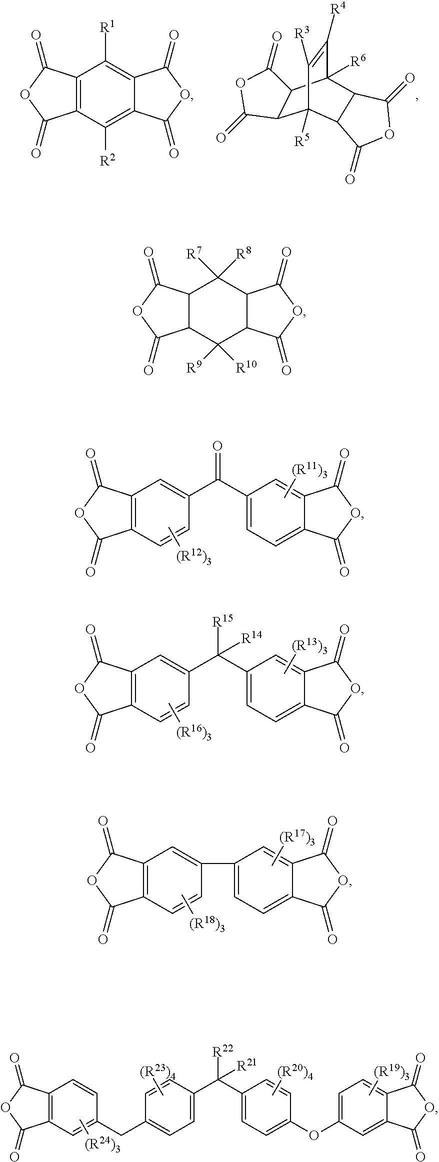
or a combination thereof; the diamine is 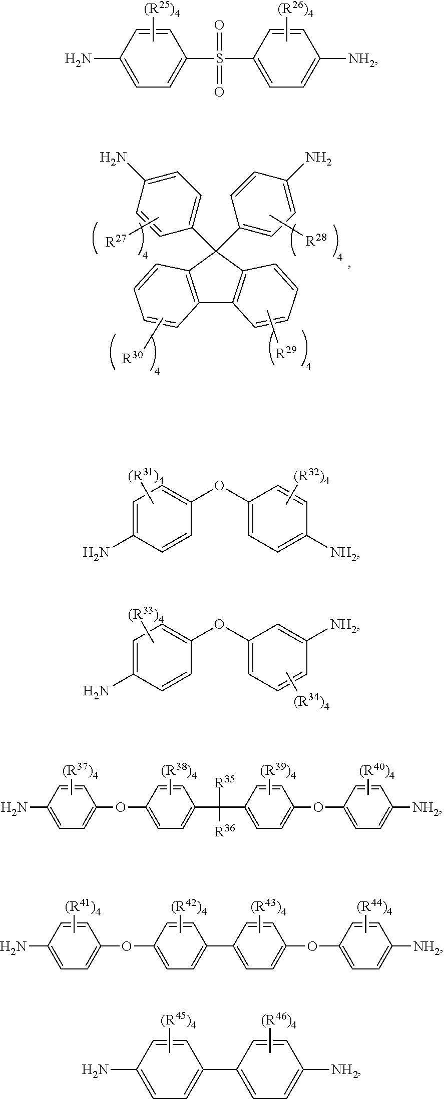
or a combination thereof;
and, R¹, R², R³, R⁴, R⁵, R⁶, R⁷, R⁸, R⁹, R¹⁰, R¹¹, R¹², R¹³, R¹⁴, R¹⁵, R¹⁶, R¹⁷, R¹⁸, R¹⁹, R²⁰, R²¹, R²², R²³, R²⁴, R²⁵, R²⁶, R²⁷, R²⁸, R²⁹, R³⁰, R³¹, R³², R³³, R³⁴, R³⁵, R³⁶, R³⁷, R³⁸, R³⁹, R⁴⁰, R⁴¹, R⁴², R⁴³, R⁴⁴, R⁴⁵, or R⁴⁶ are independently hydrogen, fluorine, C₁₋₃ alkyl group, or C₁₋₃ fluoroalkyl group;
20 to 80 parts by weight of a silicon oxide nanoparticle, wherein a total weight of the polyimide and the silicon oxide nanoparticle is 100 parts by weight;
1 to 50 parts by weight of an electrochromic material; and
850 to 1200 parts by weight of an organic substance.

2. The electrochromic composition as claimed in claim 1, wherein the solid content of the electrochromic composition is 8 wt % to 15 wt %.

3. The electrochromic composition as claimed in claim 1, wherein the dianhydride is pyromellitic dianhydride (PMDA), bicyclo [2.2.2] oct-7-ene-2,3,5,6-tetracarboxylic dianhydride (B1317), 1,2,4,5-cyclohexanetetracarboxylic dianhydride (HPMDA), 3,3′,4,4′ -benzophenonetetracarboxylic dianhydride (BTDA), 4,4′-(hexafluoroisopropylidene)diphthalic anhydride (6FDA), 3,3,4,4-biphenyl tetracarboylic dianhydride (s-BPDA), 2,2-bis[4-(3,4-dicarboxyphenoxy)phenyl]propanedianhydride (BPADA) or a combination thereof.

4. The electrochromic composition as claimed in claim 1, wherein the diamine is 4,4′-oxydianiline (ODA), 2,2-bis [4-(4-aminophenoxy)phenyl] propane (BAPP), 4,4′-(1,1′-biphenyl-4,4′-diyldioxy)dianiline (BAPB), 2,2-bis[4-(4-aminophenoxy)phenyl]hexafluoropropane (HFBAPP), 2,2′-bis(trifluoromethyl) 4,4′-diaminobiphenyl (TFMB), 4,4-diaminodiphenyl sulfone (4,4′-DDS), 4,4′-diamino-2,2′-dimethylbiphenyl (m-TBHG), 9,9-bis(4-aminophenyl)fluorene (BAFL) or a combination thereof.

5. The electrochromic composition as claimed in claim 1, wherein the silicon oxide nanoparticle is spherical silicon oxide nanoparticle.

6. The electrochromic composition as claimed in claim 1, wherein the silicon oxide nanoparticle has a particle size of 10 nm to 100 nm.

7. The electrochromic composition as claimed in claim 1, wherein the electrochromic material comprises a cathode electrochromic material, an anode electrochromic material, or a combination thereof.

8. The electrochromic composition as claimed in claim 7, wherein the cathode electrochromic material comprises 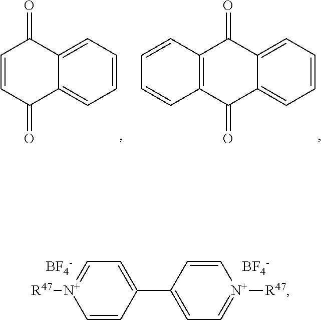
or a combination thereof, wherein R⁴⁷ is independently hydrogen, or C₁₋₁₀ alkyl group.

9. The electrochromic composition as claimed in claim 7, wherein the anode electrochromic material is 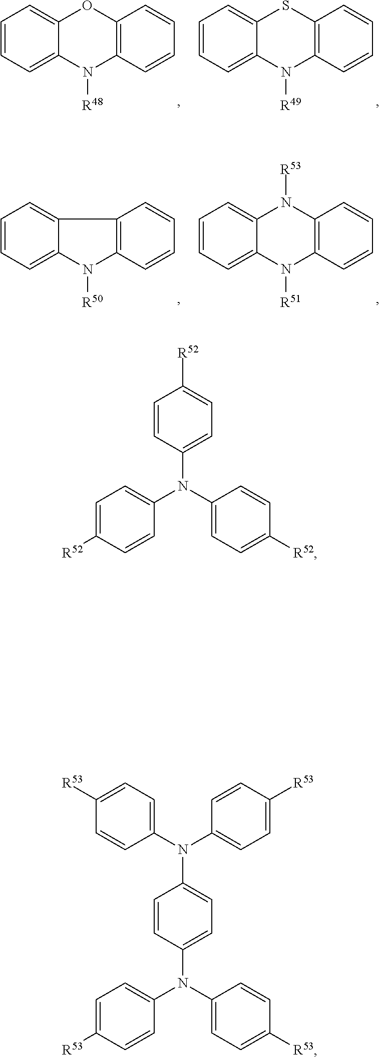
or a combination thereof, wherein R⁴⁸, R⁴⁹, R⁵⁰, or R⁵¹ are independently hydrogen, C₁₋₁₀ alkyl group, or phenyl group; and, R⁵², or R⁵³ are independently hydrogen, amine, or C₁₋₃ alkoxy group.

10. The electrochromic composition as claimed in claim 1, wherein the organic substance is ethylene carbonate (EC), propyl acetate (PA), diethyl carbonate (DEC), dimethyl carbonate (DMC), ethylmethyl carbonate (EMC),γ-butyrolactone (GBL), propylene carbonate (PC), or a combination thereof.

11. The electrochromic composition as claimed in claim 1, further comprising:
an electrolyte salt.

12. The electrochromic composition as claimed in claim 11, wherein the electrolyte salt is organic ammonium salt, lithium salt, or a combination thereof.

13. The electrochromic composition as claimed in claim 11, wherein a concentration of the electrolyte salt in the electrochromic composition is 0.01M to 3.0M.

14. The electrochromic composition as claimed in claim 1, wherein a viscosity of the electrochromic composition is 1,000 cps to 35,000 cps.

15. An electrochromic layer, wherein the electrochromic layer is made of the electrochromic composition as claimed in claim 1.

16. The electrochromic layer as claimed in claim 15, wherein the thickness of the electrochromic layer is 1 μm to 200 μm.

17. An electrochromic device, comprising:
a first conductive layer;
a second conductive layer; and
the electrochromic layer as claimed in claim 15, wherein the electrochromic layer has a top surface and a bottom surface, wherein the first conductive layer and the second conductive layer are both disposed on the bottom surface of the electrochromic layer, or the first conductive layer is disposed on the top surface of the electrochromic layer and the second conductive layer is disposed on the bottom surface of the electrochromic layer.

18. The electrochromic device as claimed in claim 17, wherein the first conductive layer is disposed on the top surface of the electrochromic layer and the second conductive layer is disposed on the bottom surface of the electrochromic layer, and at least one of the first conductive layer and the second conductive layer is a transparent conductive layer.

19. The electrochromic device as claimed in claim 17, further comprising:
a thin film transistor array substrate, wherein the first conductive layer is disposed on the top surface of the electrochromic layer and the second conductive layer is disposed on the bottom surface of the electrochromic layer, and the second conductive layer is an electrode of the thin film transistor array substrate.

20. The electrochromic device as claimed in claim 17, wherein the first conductive layer and the second conductive layer are both disposed on the bottom surface of the electrochromic layer, and the first conductive layer is separated from the second conductive layer by a space.

21. The electrochromic device as claimed in claim 17, wherein the first conductive layer and the second conductive layer are both disposed on the bottom surface of the electrochromic layer, and a pattern of the first conductive layer is complementary to a pattern of the second conductive layer.
